(19) United States
(12) Patent Application Publication
(10) Pub. No.: US 2004/0232591 A1
(43) Pub. Date: Nov. 25, 2004

(54) Process for manufacturing a composite article

(76) Inventors: Ulrich Dajek, Leverkusen (DE); Hubert Goldbach, Ratingen (DE)

Correspondence Address: BAYER MATERIAL SCIENCE LLC, 100 BAYER ROAD, PITTSBURGH, PA, 15205, US

(21) Appl. No.: 10/823,422

(22) Filed: Apr. 13, 2004

(30) Foreign Application Priority Data
Apr. 15, 2003 (DE) 10317218.1

(51) Int. Cl. B29C 31/00

(52) U.S. Cl. 264/259; 264/274

(57) ABSTRACT

A process for manufacturing a composite article which includes at least one part fabricated from metal and/or plastic material is described. The process includes: (a) placing a part (1, 1′) into a mold (not shown); and (b) closing the mold and concurrently deforming at least a portion of the edge region (2, 2′) of at least one part (1, 1′), thus forming a deformed edge region (11, 14, 17). The deformed edge region may be selected from: (i) at least one aligned edge region (17) which includes at least two edge portions (6, 6′) that are aligned side-by-side; and/or (ii) at least one abutting edge region (11, 14) which includes two edge regions (2, 2′) abutting one over the other. In a subsequent step (c), plastic material (4) is introduced (e.g., injected) into the mold and over the deformed edge region (11, 14, 17). The combination of the concurrent deformation of the edge portions (2, 2′) and molding of plastic material (4) over the deformed edge regions (11, 14, 17) serves to fixedly attach the edge regions (2, 2′) of the deformed edge region (11, 14, 17) together, thus forming the composite article.

### CROSS REFERENCE TO RELATED PATENT APPLICATION

The present patent application claims the right of priority under 35 U.S.C. §119 (a)-(d) of German Patent Application No. 103 17 218.1, filed Apr. 15, 2003.

### FIELD OF THE INVENTION

The invention relates to a process for manufacturing a composite article (e.g., a plastic/metal composite article), in which the parts of the composite article are connected by being joined and by means of molded-on thermoplastic material.

### BACKGROUND OF THE INVENTION

Plastic/metal composite parts in the form of hollow chamber composite parts are known for example from DE-A 198 48 516. To connect the half-shell to the cover plate or cover shell, molded-on thermoplastic material may be used. For this purpose, the half-shell and the cover plate have for example a peripheral edge which is provided with apertures to which for example rivet connections made from molded-on plastic material are attached. Alternatively, or in addition thereto, beads on which a form-fitting connection of high shear strength may similarly be made by means of molded-on plastic material may also be provided. Moreover, DE-A 198 48 516 also discloses other processes for connecting two or more moldings, such as welding, adhesion, flanging, clinching and riveting, which may be used individually or in combination in order to connect moldings.

DE-A 195 00 790 discloses a process and a device for manufacturing plastic/metal composite parts by combining a metal joining technique and conventional injection molding processes in the cavity of a modified injection mold. In this case, in a first step individual metal sheets or sheet-metal profiles to be connected are laid in the injection mold and connected form-fittingly to one another by pressing or joining using a press punch. In a second step, by molding plastic material on, the sheet-metal parts are additionally connected to one another in the region of the joining or pressing point and/or other apertures in the metal sheets or sheet-metal profiles that are located one above the other. The device for carrying out the process has one or more joining or press punches in the cavity of the injection mold, where appropriate with corresponding lower punches at those points at which the individual sheets are joined together. The punches are retracted out of the cavity of the injection mold so that the plastic material can be molded on.

One disadvantage of the process known from DE-A 195 00 790 consists in the fact that the moldings are pressed and the plastic material is molded on in one device but in two separate process steps. The pressing or stamping is a separate process step in which movable punches are pressed onto the moldings in the injection mold. The press punches are let into the injection mold. According to DE-A 195 00 790, the punches are extended inside the closed injection mold in order to press the moldings and retracted again before the thermoplastic material is injected into the cavity of the injection mold. The cycle time for the manufacture of a composite part is correspondingly relatively long. It is also disadvantageous that the device required is relatively complex, since it has movable punches for pressing the moldings.

Plastic/metal composite parts, which are capable of undergoing high mechanical stress, may be used as lightweight components, for example in automotive construction.

### SUMMARY OF THE INVENTION

In accordance with the present invention, there is provided a process for manufacturing a composite article comprising at least one part fabricated from a material selected from the group consisting of metal, plastic material and combinations thereof, each part having at least one edge region, said process comprising:

(a) placing said part (1, 1′) into a mold (not shown);

(b) closing said mold and concurrently deforming at least a portion of the edge region (2, 2′) of at least one part (1, 1′) thus forming a deformed edge region (11, 14, 17) selected from at least one of,

(i) at least one aligned edge region (17) comprising at least two edge portions (6, 6′) that are aligned side-by-side, and

(ii) at least one abutting edge region (11, 14) comprising two edge regions (2, 2′) abutting one over the other; and

(c) introducing plastic (4) into said mold and over said deformed edge region (11, 14, 17), thereby fixedly attaching the edge regions (2, 2′) of said deformed edge region (11, 14, 17) together and forming said composite article.

The features that characterize the present invention are pointed out with particularity in the claims, which are annexed to and form a part of this disclosure. These and other features of the invention, its operating advantages and the specific objects obtained by its use will be more fully understood from the following detailed description and accompanying drawings in which preferred embodiments of the invention are illustrated and described.

Unless otherwise indicated, all numbers or expressions, such as those expressing structural dimensions, quantities of ingredients, etc. used in the specification and claims are understood as modified in all instances by the term “about.”

### BRIEF DESCRIPTION OF THE DRAWING FIGURES

FIG. 1 is a representative perspective view of a composite article according the present invention (in the absence of molded-over plastic), in which the deformed edge region (11) is an abutting edge region formed by stamping the edge regions (2, 2′) together as the injection mold is closed;

FIG. 2 is a sectional representation of the abutting edge region (11) of FIG. 1 with plastic material (4) molded there over;

FIG. 3 is a sectional representation of an abutting edge region (14) that includes an aligned aperture (7) that is formed by pushing the edges (35) of aperture (29) of edge region (2) through aperture (32) of underlying edge region (2′);

FIG. 4 is a representative perspective view of a composite article according the present invention (in the absence of molded over plastic), in which the deformed edge region (17) is an aligned edge region formed from edge portions (tabs 6, 6′) being aligned side-by-side; and

FIG. 5 is a sectional representation of aligned edge region (17) of FIG. 4 with plastic material (4) molded there over.

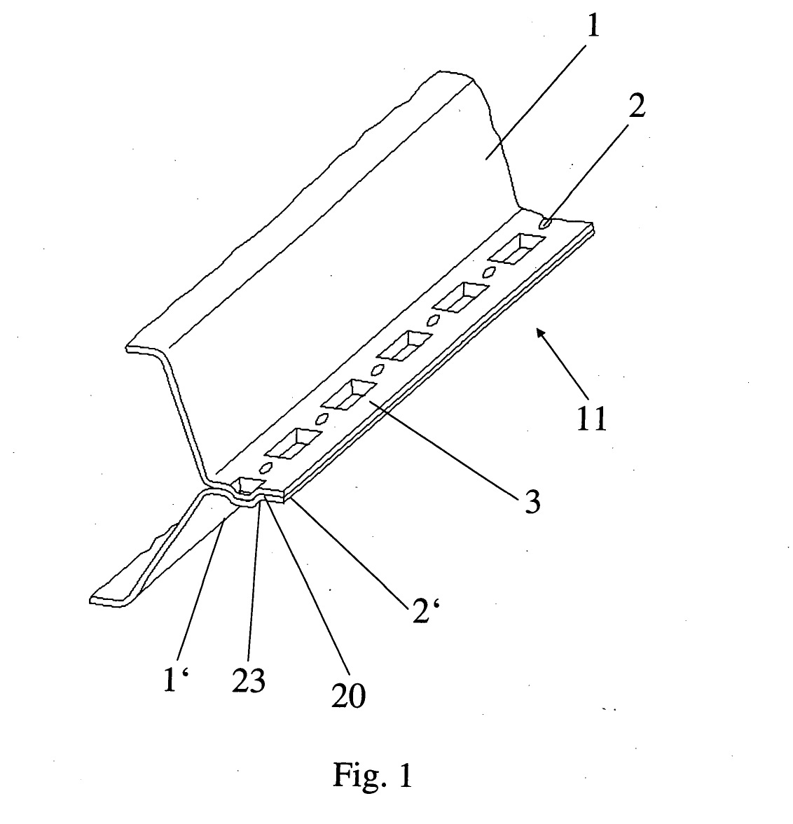

In FIGS. 1 through 5, like reference numerals designate the same operations and components.

### DETAILED DESCRIPTION OF THE INVENTION

The composite part according to the invention is composed of at least one part. The part may have any geometric shape. The composite article may for example comprise one single part, for example a rolled profile, which may be joined to form a twin-wall composite article. The composite article may for example be formed from two parts, in which case the parts may for example be two half-shells or one half-shell and a cover plate which together form a hollow chamber composite article.

According to the invention, the form-fitting connection (fixed attachment) of high shear strength of the part or parts which are laid in the injection mold is formed by joining as the injection mold is closed.

In an embodiment of the process according to the invention, joining is carried out by stamping as the injection mold is closed. For this purpose, the injection mold has stamping punches or stamping cores which during closing press onto the parts and stamp them. In the closed injection mold, the stamping cores project into the cavity of the injection mold, so that the stamping cores press onto the parts lying in the mold cavity. The parts preferably have an edge region in which the parts lie one against the other or one above the other (in an abutting relationship). Preferably, stamping is carried out in the edge region of the parts lying one against the other. Similarly, a one-piece part preferably has two edge regions which are laid one above the other or one against the other in order to be connected. The stamping may be carried out on one side or from both sides. When stamping is carried out from both sides, the stamping cores press alternately against the one and the other part along the edge region. Where the edge region of the parts lies substantially horizontally in the injection mold, stamping of the edge region from both sides is carried out by stamping cores from above and below.

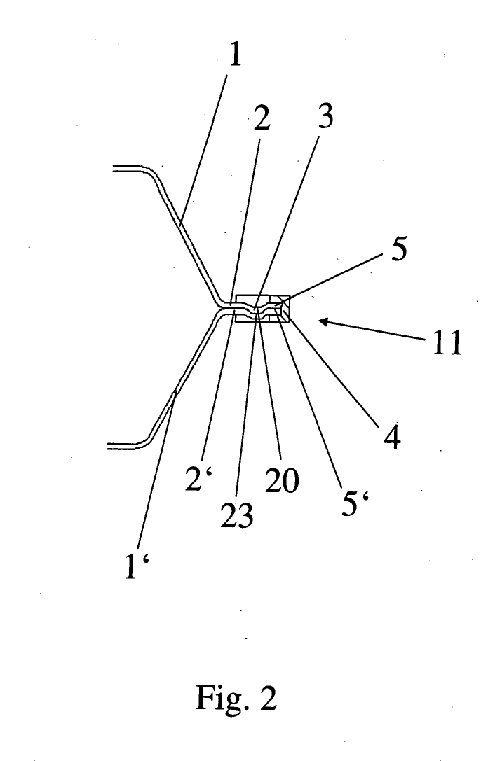

With reference to FIGS. 1 and 2, the stamping of edge regions (2, 2′) results in the formation of aligned beads (or deformations) (3) in abutting edge region (11). The aligned beads (3) include a bead (20) in edge region (2) which is aligned with and abuts a bead (23) in underlying edge region (2′). The aligned beads (3) are encased in molded-on plastic (4) when plastic is introduced (e.g., injected) into the mold (not shown).

A further possibility of connecting two parts to one another by joining as the injection mold is closed is by, what is referred to herein as, “passing through them” and similar terms. In this case, the parts have apertures lying one above the other in their edge regions lying one above the other. Passing through is carried out, once again as the injection mold is closed, by the edges of the apertures being shaped with the aid of the stamping cores, in a manner similar to flanging. In a process variant, the apertures lying one above the other are not of the same size. Substantially round apertures may for example have different diameters. Then, as the injection mold is closed only the molding which has the smaller apertures is shaped. The edges of the smaller apertures are shaped with the aid of the stamping cores such that they project into the larger apertures of the other part.

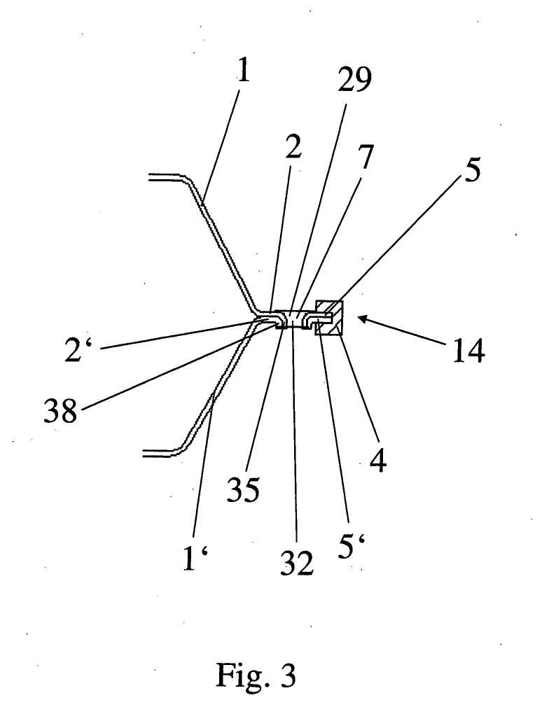

With reference to FIG. 3, the edge region (2, 2′) of each part (1, 1′) has at least one aperture (29, 32) having edges (35, 38). At least two of the apertures (29, 32) are aligned and together form an aligned aperture (7). The abutting edge region (14) has at least one aligned aperture (7). Preferably, at least a portion of the edges (35) of one aperture (29) of the aligned aperture (7) are deformed through the other aperture (32) of the aligned aperture (7) when the mold (not shown) is closed. Plastic material (4) may be molded over the terminal edges (5, 5′) of abutting edge region (14) as depicted in FIG. 3. In a further embodiment, the plastic (4) molded over the deformed edge region (14) passes through at least one of the aligned apertures (7). The edges (35, 38) of the aligned apertures (7) may be embedded in the plastic material (4) passing there-through (not shown in FIG. 3).

Furthermore, in an embodiment of the present invention, only one of the parts has apertures in the edge region, while the part lying against it has no apertures but covers up the apertures in the first part. As the injection mold is closed, the two parts are stamped to one another, with the region of the apertures in the covering part being pressed into the apertures in the molding lying against it.

In a further embodiment of the process according to the invention, the joining consists in interlinking or meshing the two parts to one another as the injection mold is closed. In this embodiment, the parts preferably do not have a continuous edge region. Instead, the edge region is constructed only in individual sections, in the manner of tabs. The width and geometry of the tabs and the spacing between two adjacent tabs may be selected as desired. In the simplest shape, the width of the tabs is substantially equal to the spacing between two adjacent tabs. The tabs of the two parts are positioned exactly such that when the parts are laid one against the other or one above the other the tabs of the one part fit into the gap between two adjacent tabs on the other part. As the injection mold is closed, the stamping cores press the tabs of the parts together, so that the tabs engage in one another and come to lie in substantially one plane. In this way, the pressed tabs form a continuous closed edge region.

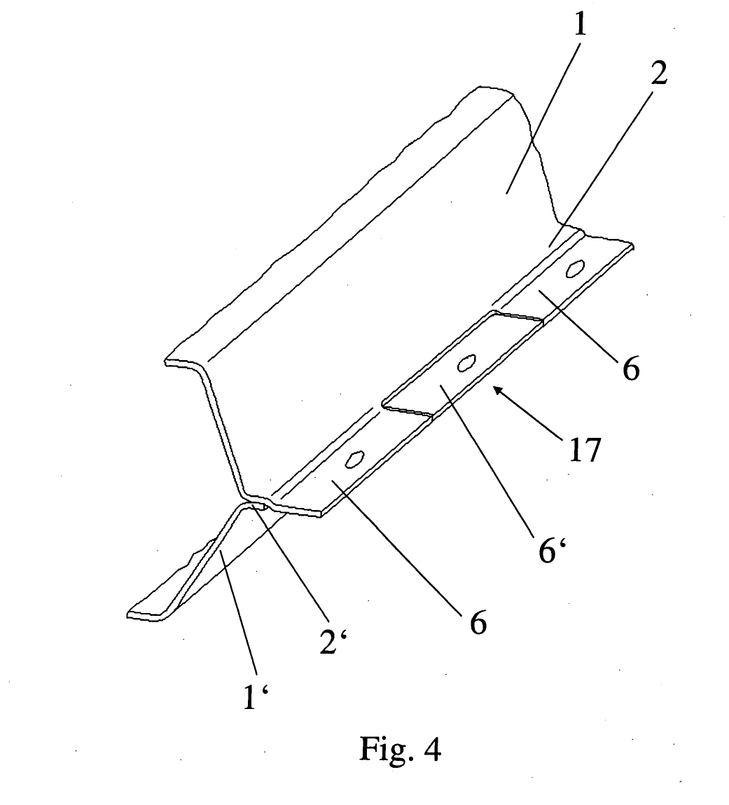

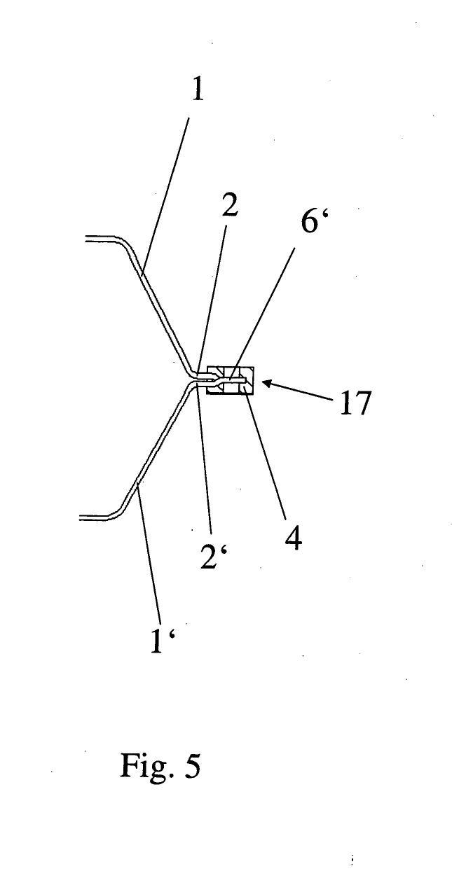

With reference to FIGS. 4 and 5, each edge region (2, 2′) may include at least one tab (6, 6′), at least one of the tabs (e.g., 6) of one edge region (e.g., 2) is deformed such that it is aligned side-by-side with at least one of the tabs (e.g., 6′) of another edge region (e.g., 2′), thereby forming the aligned edge region (17). Alternatively or in addition thereto, both tabs (6, 6′) may be concurrently deformed such that they form the aligned edge region (17). With regard to aligned edge regions (e.g., 17), as used herein and in the claims, the term “side-by-side” means that the edge portions (such as tabs 6 and 6′) are aligned substantially within the same plane, and one tab may or may not touch or abut its neighboring tab. In a preferred embodiment, the aligned tabs (6, 6′) are interlinked with each other. With regard to aligned edge regions (e.g., 17), as used herein and in the claims, the term “interlinked” means the edge portions (e.g., aligned tabs 6 and 6′) are both substantially aligned within the same plane and each aligned tab abuts its neighboring aligned tab. The aligned tabs (6, 6′) are encased in the plastic material (4) molded over the deformed edge region (17).

In a further embodiment, to interlink the parts with one another, because of the relatively high stability and in a particularly preferable manner only one of the two parts has tabs, of any geometric shape, for example round or polygonal. The other part has a continuous edge region with apertures for receiving the tabs of the first part. The geometry and size of the apertures are selected such that they form the counterpart piece to the tabs and exactly receive the tabs. As the injection mold is closed, the tabs of the one part are inserted into the apertures in the other part, forming a continuous closed edge region.

It is also possible to combine the different embodiments of joining as the injection mold is closed.

In order, in addition to the stamped form-fitting connection of high shear strength of the parts to one another, to achieve sufficient resistance to being detached from one another, the parts are additionally connected to one another by molded-on thermoplastic material. The thermoplastic material is molded on in the same injection mold. For this, the parts preferably have, in particular in their edge region, apertures and/or beads in the region whereof the plastic material is molded on and passes through the apertures or into the beads. In addition or alternatively, part may also be carried out around the edges of the parts. Further processes for connecting parts by means of molded-on thermoplastic material are described for example in DE-A 198 48 516.

The advantage of the process according to the invention consists in the fact that for the joining, in particular stamping, passing through and/or meshing, no additional working step is now required, but rather the joining takes place in one step at the same time as the injection mold is closed. This has the additional advantage that the injection mold no longer has any moving parts such as punches and the like which are movable up and down in the closed injection mold-or-are extended and retracted again. The injection mold only has pegs or the like which press onto the parts as the injection mold is closed.

The parts may be fabricated from: metal, in particular steel, nickel, chromium, iron, copper, zinc, titanium, aluminum, magnesium and alloys of these metals; or from plastic material, in particular unreinforced, reinforced and/or filled thermoplastic material, such as polycarbonate (PC), thermoplastic polyurethane (PU), polyester, in particular polyethylene terephthalate (PET), polystyrene (PS), syndiotactic polystyrene, acrylonitrile-butadiene-styrene (ABS), polypropylene oxide (PPO), polysulphone (PSU), polyphenylene sulphide (PPS), polyimide (PI), polyether ether ketone (PEEK), polyamide (PA), polybutylene terephthalate (PBT), polypropylene (PP), polyethylene (PE) or a mixture of these plastic materials.

As the thermoplastic material for form-fittingly connecting the parts to one another, particularly suitable is an unreinforced, reinforced and/or filled plastic material based on polyamide (PA), polyester, in particular polyethylene terephthalate (PET), polybutylene terephthalate (PBT), polystyrene (PS), syndiotactic polystyrene, acrylonitrile-butadiene-styrene (ABS), polybutylene terephthalate (PBT), thermoplastic polyurethane (PU), polyolefin, in particular polypropylene (PP), polyethylene (PE), polycarbonate (PC), polypropylene oxide (PPO), polysulphone (PSU), polyphenylene sulphide (PPS), polyimide (PI), polyether ether ketone (PEEK) or a mixture of these plastic materials.

The invention will be explained below in more detail with reference to the attached drawings.

FIG. 1 illustrates a portion comprising two half-shells 1, 1′ which have an edge region 2, 2′. The edge regions 2, 2′ lie against one another (abut each other). In the edge region 2, 2 the two half-shells 1, 1′ have been stamped inside the cavity of the injection mold (not illustrated) as the injection mold was closed, and include aligned beads 3.

FIG. 2 shows a portion of the two half-shells 1, 1′ which were stamped to one another for the purpose of being connected to one another in the edge region 2, 2′ as the injection mold was closed and whereof the terminal edges 5, 5′ have then had plastic material 4 molded around them in the same injection mold.

One embodiment of the process according to the invention which is illustrated in FIG. 3 is passing through. Here, the two half-shells 1, 1′ have an abutting edge region (14) comprising edge regions 2 and 2′, in which there are aligned apertures 7 (formed by the alignment of apertures 29 and 32). As the injection mold (not shown) is closed the edges (35 and 38) of the apertures (29 and 32) are shaped such that a form-fitting connection of high shear strength is created.

FIG. 4 shows joining as a result of meshing two parts with the aid of tabs. FIG. 4 illustrates a portion comprising two half-shells 1, 1′ which have tabs 6, 6′ in their edge region 2, 2′. The width of the tabs 6, 6′ and the spacing between two adjacent tabs 6 of the half-shell 1 or two adjacent tabs 6′ of the half-shell 1′ are selected such that as the injection mold (not illustrated) is closed, a tab 6 is pressed into the gap between two adjacent tabs 6′ and vice versa. The tabs are pressed substantially into one plane as the mold is closed, and so form a continuous closed (or aligned) edge region (17).

FIG. 5 shows the composite article-illustrated in FIG. 4, in cross-section. Visible in the edge region 2′ of the lower half-shell 1′ is a tab 6′ which has been pressed upwards as the injection mold was closed. It forms one plane, along the alinged edge region (17), with the tabs 6 of the upper half-shell 1 and the tabs 6′ of the lower half-shell 1′. In addition, plastic material 4 has been molded around edge regions 2, 2′ of aligned edge region (17).

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A process for manufacturing a composite article comprising at least one part fabricated from a material selected from the group consisting of metal, plastic material and combinations thereof, each part having at least one edge region, said process comprising:
(a) placing said part into a mold;
(b) closing said mold and concurrently deforming at least a portion of the edge region of at least one part thus forming a deformed edge region selected from at least one of,
(i) at least one aligned edge region comprising at least two edge portions that are aligned side-by-side, and
(ii) at least one-abutting edge region comprising two edge regions abutting one over the other; and
(c) introducing plastic into said mold and over said deformed edge region, thereby fixedly attaching the edge regions of said deformed edge region together and forming said composite article.

2. The process of claim 1 wherein said abutting edge region is formed by stamping said edge regions together.

3. The process of claim 2 wherein the stamping of said edge regions results in the formation of aligned beads in said abutting edge region.

4. The process of claim 3 wherein said aligned beads are encased in the plastic material molded over said deformed edge region.

5. The process of claim 1 wherein each edge region of said part has at least one aperture having edges, at least two of said apertures being aligned and together forming an aligned aperture, said abutting edge region having at least one aligned aperture, at least a portion of the edges of one aperture of said aligned aperture being deformed through the other aperture of said aligned aperture when said mold is closed.

6. The process of claim 5 wherein the plastic molded over said deformed edge region passes through at least one of said aligned apertures, the edges of said aligned aperture being embedded in the plastic material passing there-through.

7. The process of claim 1 wherein each edge region comprises at least one tab, at least one of said tabs of one edge region being deformed such that it is aligned side-by-side with at least one of the tabs of another edge region, thereby forming said aligned edge region.

8. The process of claim 7 wherein the aligned tabs are interlinked with each other.

9. The process of claim 7 wherein said aligned tabs are encased in the plastic material molded over said deformed edge region.
